(19) United States
(12) Patent Application Publication
(10) Pub. No.: US 2015/0131576 A1
(43) Pub. Date: May 14, 2015

(54) METHOD AND APPARATUS FOR ALLOCATING RESOURCE IN CELLULAR COMMUNICATION SYSTEM

(71) Applicant: ELECTRONICS AND TELECOMMUNICATIONS RESEARCH INSTITUTE, Daejeon (KR)

(72) Inventors: Seok SEO, Daejeon (KR); Jae Su SONG, Daejeon (KR); Yunhee CHO, Daejeon (KR); Seung-Hwan LEE, Daejeon (KR)

(73) Assignee: ELECTRONICS AND TELECOMMUNICATIONS RESEARCH INSTITUTE, Daejeon (KR)

(21) Appl. No.: 14/530,869

(22) Filed: Nov. 3, 2014

(30) Foreign Application Priority Data
Nov. 8, 2013 (KR) 10-2013-0135820

(51) Int. Cl. H04W 72/04; H04L 5/00

(52) U.S. Cl. CPC H04W 72/0453; H04L 5/003
USPC 370/329

(57) ABSTRACT

A resource allocation apparatus of a cellular communication system including a plurality of cells divides an entire frequency band into a first frequency band to allocate to a cell central area and a second frequency band to allocate to a cell boundary area, divides the second frequency band into a plurality of subbands, allocates the first frequency band or the second frequency band to a terminal within each cell, and adjusts adaptively a size of the first frequency band or the second frequency band according to load distribution information of each cell. The plurality of cells use commonly the first frequency band and the second frequency band is operated with a resource pool method.

### CROSS-REFERENCE TO RELATED APPLICATION

This application claims priority to and the benefit of Korean Patent Application No. 10-201 3-01 35820 filed in the Korean Intellectual Property Office on Nov. 8, 2013, the entire contents of which are incorporated herein by reference.

### BACKGROUND OF THE INVENTION

(a) Field of the Invention

The present invention relates to a method and apparatus for allocating a resource in a cellular communication system. More particularly, the present invention relates to a method and apparatus for allocating adaptively a resource according to a change of a user distribution and a load level even while removing inter-cell interference.

(b) Description of the Related Art

In general, in order to maximize a system capacity by efficiently using a radio resource, an entire service area is divided into a plurality of cells to configure a multi-cell, and a radio resource such as a frequency is reused. And a base station for providing services to terminals positioned in a cell is installed in each of the cells.

In such a cellular communication system, in order to enhance system capacity, frequency usage efficiency should be maximized. For this purpose, each cell is designed to commonly use an entire frequency band. When neighboring cells use the same frequency band, interference is generated among the cells. The interference generated among the cells is referred to as inter-cell interference.

In particular, the inter-cell interference does not significantly matter in terminals positioned in a center region of a cell since intensities of signals received from others cells are small and that of a signal received from a serving cell is large. However, the inter-cell interference significantly deteriorates communication performance of terminals positioned in an edge region of a cell since intensities of signals received from neighboring cells are large.

### SUMMARY OF THE INVENTION

The present invention has been made in an effort to provide a method and apparatus for allocating a resource in a cellular communication system having advantages of being capable of adaptively allocating a resource according to a change of a user distribution and a load level even while removing inter-cell interference.

An exemplary embodiment of the present invention provides a method in which a resource allocation apparatus of a cellular communication system including a plurality of cells allocates a resource. The method includes: dividing an entire frequency band into a first frequency band to allocate to a cell central area and a second frequency band to allocate to a cell boundary area; dividing the second frequency band into a plurality of subbands; allocating the first frequency band or the second frequency band to a terminal within each cell; and adjusting a size of the first frequency band and the second frequency band according to load distribution information of each cell, wherein, the plurality of cells use commonly the first frequency band, and the second frequency band is operated with a resource pool method.

The allocating of the first frequency band or the second frequency band may include: classifying a terminal within each cell as a cell central user that is located at the cell center area or a cell boundary user that is located at the cell boundary area; allocating a portion of the first frequency band to a terminal that is classified as the cell central user; and allocating at least one subband of a plurality of subbands of a second frequency band to a terminal that is classified as the cell boundary user.

The allocating of at least one subband may include: calculating quality of a channel that is allocated to a cell boundary area of a corresponding cell on a subband basis; and allocating the at least one subband based on the channel quality on a subband basis.

The calculating of a channel quality may include calculating channel quality of the corresponding subband, by a product of information about an availability of the corresponding subband and channel state information of a corresponding subband, wherein the information about the availability of the subband may be represented with a bit 0 or a bit 1.

The allocating of at least one subband may include allocating a subband different from that of a cell boundary user of adjacent cells.

The allocating of the second frequency band may further include allocating the at least one subband and updating information about the availability of the plurality of subbands.

The updating of information may include reporting information data about the availability of the plurality of subbands to a base station of adjacent cells.

The reporting of information data may include reporting an index of an updated subband and information about the availability of an updated subband.

The information about the availability of the plurality of subbands may be represented with a bit 0 or a bit 1, and each bit position of information data about the availability of the plurality of subbands may correspond to a position of each subband.

The adjusting of a size may include additionally allocating, if a traffic load or a user load of the cell boundary area is larger than a predetermined threshold value, a portion of the first frequency band to the second frequency band.

The adjusting of a size may include additionally allocating, if a traffic load or a user load of the cell central area is larger than a predetermined threshold value, a portion of the second frequency band to the first frequency band.

Another embodiment of the present invention provides a resource allocation apparatus within each cell in a cellular communication system including a plurality of cells. The resource allocation apparatus includes a receiver and a controller. The receiver acquires channel state information of a terminal within a cell. The controller allocates a portion of a first frequency band to a terminal that is classified as a cell central user, allocates at least one subband of a plurality of subbands of a second frequency band to a terminal that is classified as a cell boundary user, and adjusts a size of the first frequency band and the second frequency band according to load distribution information of the cell.

The controller may calculate quality of a channel that is allocated to a cell boundary area of a corresponding cell on a subband basis, by a product of information about the availability of a corresponding subband and channel quality information of a corresponding subband, wherein the information about the availability of a subband may be represented with a bit 0 or a bit 1. And the controller may allocate the at least one subband to a cell boundary user based on channel quality on a subband basis.

The controller may additionally allocate a portion of the first frequency band to the second frequency band, if a traffic load or a user load of the cell boundary area is larger than a predetermined threshold value.

The controller may update information about the availability of the plurality of subbands.

The resource allocation apparatus may further include a transmitter that transmits information about the availability of the plurality of subbands to a neighboring base station.

The resource allocation apparatus may further include a transmitter that transmits an index of an updated subband and information about the availability of the updated subband to the neighboring base station.

### BRIEF DESCRIPTION OF THE DRAWINGS

FIG. 1 is a diagram illustrating an example of a cellular communication system according to an exemplary embodiment of the present invention.

FIGS. 2 to 4 are diagrams illustrating a method of allocating a resource in a cellular communication system according to an exemplary embodiment of the present invention.

FIG. 5 is a flowchart illustrating a centralized frequency resource allocation method according to an exemplary embodiment of the present invention.

FIG. 6 is a diagram illustrating an example of a method of representing information about the availability of a subband according to an exemplary embodiment of the present invention.

FIG. 7 is a diagram illustrating an example of an information data format about the availability of a subband according to an exemplary embodiment of the present invention.

FIG. 8 is a flowchart illustrating a centralized frequency resource reallocation method according to an exemplary embodiment of the present invention.

FIG. 9 is a flowchart illustrating a distributed resource allocation method according to another exemplary embodiment of the present invention.

FIG. 10 is a diagram illustrating another example of an information data format about the availability of a subband according to an exemplary embodiment of the present invention.

FIG. 11 is a flowchart illustrating an example of a method of updating information data about the availability of a subband of a neighboring base station according to an exemplary embodiment of the present invention.

FIG. 12 is a block diagram illustrating a resource allocation apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for allocating a resource in a cellular communication system according to an exemplary embodiment of the present invention will be described in detail with reference to the drawings.

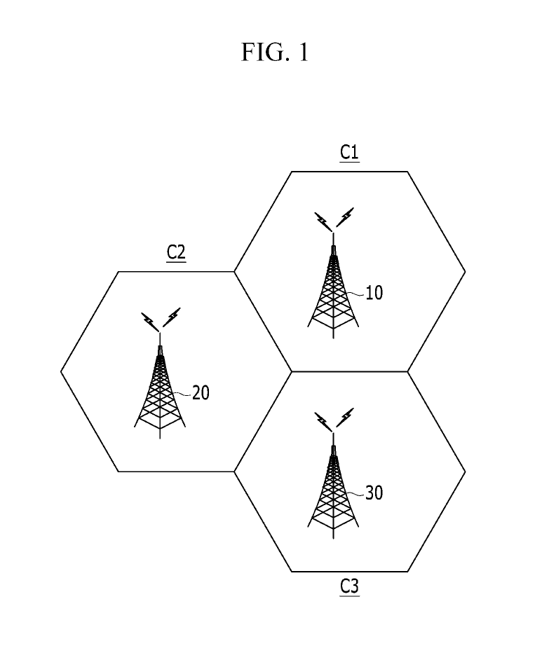

FIG. 1 is a diagram illustrating an example of a cellular communication system according to an exemplary embodiment of the present invention.

Referring to FIG. 1, the cellular communication system includes a plurality of cells C1, C2, and C3. The cells C1, C2, and C3 include base stations 10, 20, and 30, respectively. The base stations 10, 20, and 30 communicate with a terminal within the cells C1, C2, and C3, respectively, using a radio resource.

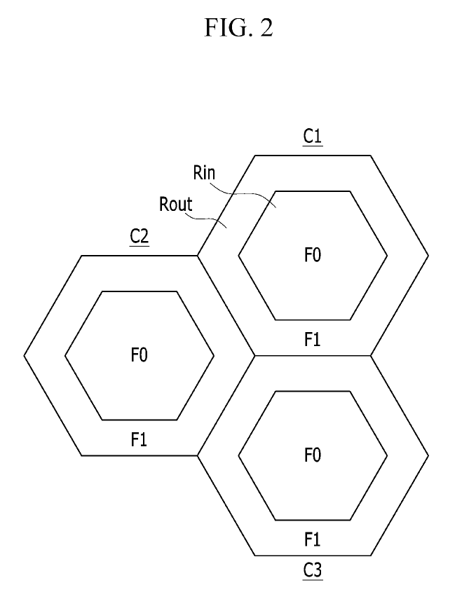

FIGS. 2 to 4 are diagrams illustrating a fractional frequency reuse (FFR) method according to an exemplary embodiment of the present invention.

As shown in FIG. 2, the cells C1, C2, and C3 each are divided into a cell central area Rin and a cell boundary area Rout.

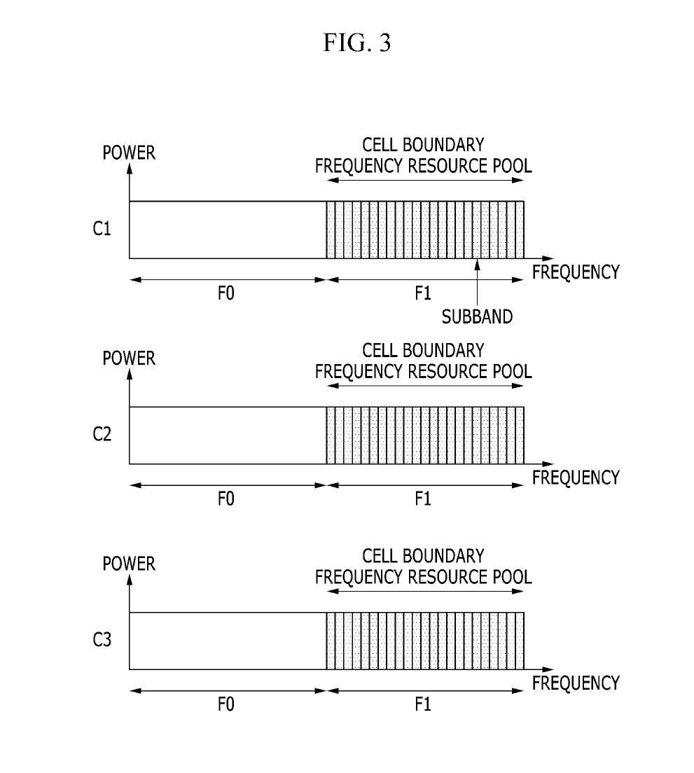

As shown in FIG. 3, an entire frequency band is divided into a frequency band F0 to be allocated to a cell central area and a frequency band F1 to be allocated to a cell boundary area, and the frequency band F1 to be allocated to the cell boundary area is divided again into a plurality of subbands such that a cell boundary frequency resource pool is formed. A frequency band F0 is commonly allocated to a cell central area of the cells C1, C2, and C3, and a plurality of subbands of the frequency band F1 are allocated to a cell boundary area of each of the cells C1, C2, and C3 by a predetermined resource allocation method.

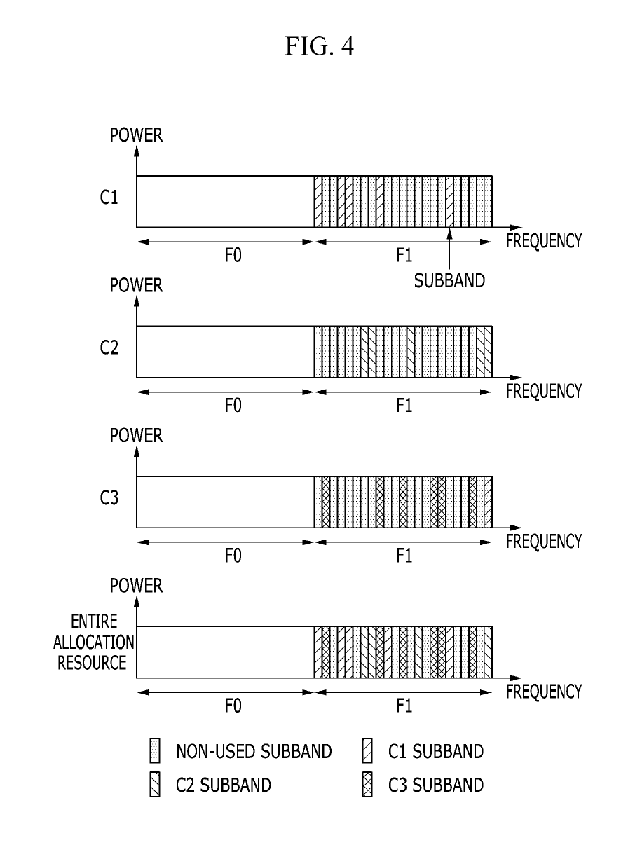

As shown in FIG. 4, a plurality of subbands of the frequency band F1 that is allocated to a cell boundary area are shared by all cells C1, C2, and C3 with a resource pool method, and are exclusively allocated to adjacent cells so that inter-cell interference does not occur. A resource pool method is an efficient operation method of a resource, in which the cells C1, C2, and C3 share a sharing resource pool and in which the cells C1, C2, and C3 allocate a resource using a resource allocation method that can maximize resource usage efficiency while minimizing inter-cell interference. Therefore, a subband that is allocated to a cell boundary area of the cell C1 is not allocated to a cell boundary area of adjacent cells C2 and C3 of the cell C1.

A frequency resource allocation method may include a centralized allocation method and a distributed allocation method.

In the centralized allocation method, a central server that manages several base stations is necessary. In the centralized allocation method, each base station reports channel state information such as a channel quality indicator (CQI), a signal-to-noise ratio (SNR), and a signal-to-interference-plus-noise-ratio (SINR) to a central server, and the central server allocates a frequency resource to a terminal using the channel state information. In this case, the central server continuously updates and manages information about the availability of a subband of the frequency band F1 that is allocated to a cell boundary area.

In a distributed allocation method, a neighboring base station shares channel state information and information about the availability of a subband, and a base station allocates a frequency resource to a terminal using such shared information. In a distributed allocation method, in order to avoid cell boundary interference, a subband of a frequency band F1 that is allocated to a cell boundary area is exclusively allocated to cell boundary terminals. Therefore, in a distributed allocation method, it is necessary to share information about the availability of a subband.

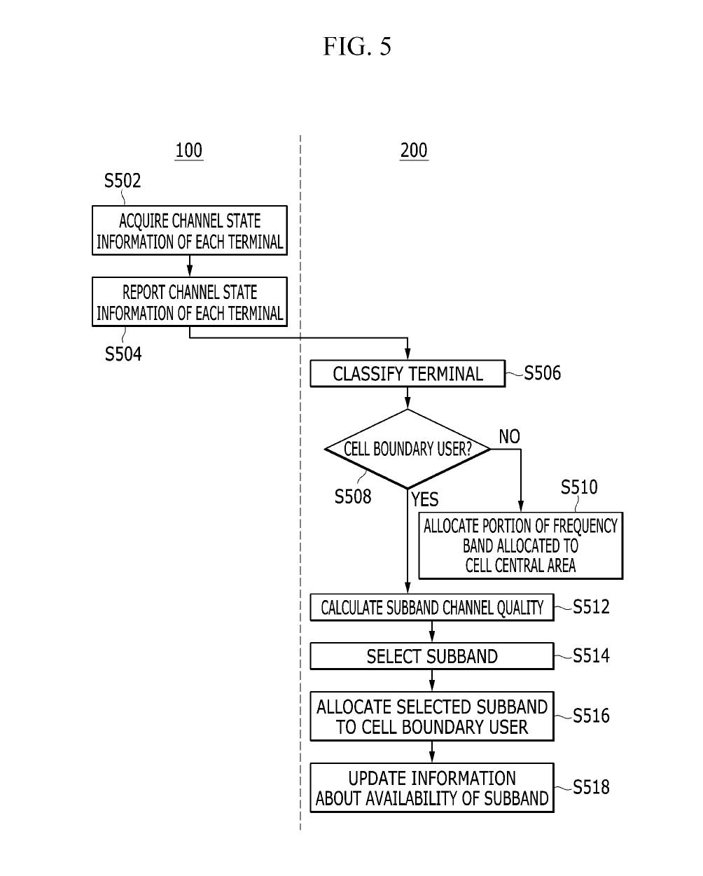

FIG. 5 is a flowchart illustrating a centralized frequency resource allocation method according to an exemplary embodiment of the present invention.

Referring to FIG. 5, a base station 100 acquires channel state information of each terminal (S502). The base station 100 receives a report of channel state information from a terminal or the base station 100 directly measures channel state information of a terminal, thereby acquiring channel state information of the terminal. The channel state information includes a channel quality indicator (CQI), a signal-to-noise ratio (SNR), and a signal-to-interference-plus-noise-ratio (SINR)

The base station 100 reports channel state information of each terminal to a central server 200 (S504).

When the central server 200 acquires channel state information of a terminal from the base station 100, the central server 200 classifies the terminal as a terminal (hereinafter referred to as a “cell central user”) that is located at the cell center or a terminal (hereinafter referred to as a “cell boundary user”) that is located at the cell boundary (S506). For example, if an SNR value of the terminal is equal to or larger than a predetermined threshold value, the central server 200 may classify the terminal as a cell central user, and if an SNR value of the terminal is less than a predetermined threshold value, the central server 200 may classify the terminal as a cell boundary user.

The central server 200 determines whether the terminal is classified as a cell boundary user (S508), and if the terminal is classified as a cell central user, the central server 200 allocates a portion of the frequency band F0 that is allocated for a cell central area service to a corresponding terminal (S510).

If the terminal is classified as a cell boundary user at step S508, the central server 200 calculates quality of a channel that is allocated to a cell boundary area of a corresponding cell on a subband basis (S512).

The central server 200 multiplies channel state information of each subband and information about the availability of a subband, thereby calculating channel quality of each subband. The information about the availability of a subband may be represented with a bit 1 or a bit 0. Because the information about the availability of a subband may be represented with 1 or 0, channel quality of each subband may be calculated by operation with very low complexity. For example, a subband being used may be represented with a bit 0 and a non-used subband may be represented with a bit 1.

When channel quality of each subband is Cᵢ, channel quality of each subband may be calculated by Equation 1.

Cᵢ=Hᵢ*U (Equation 1)

Here, i represents each subband index, Hᵢ represents channel state information of an i-th subband, and Uᵢ represents information about the availability of an i-th subband and has a value of 0 or 1.

The central server 200 selects a subband with the best channel quality based on a channel quality value that is calculated on a subband basis (S514). When it is assumed that a subband being used is represented with a bit 0 and a non-used subband is represented with a bit 1, and a channel with a large channel state value is a good channel, the central server 200 may select a subband with the largest Cᵢ value.

The central server 200 allocates the selected subband to a corresponding cell boundary user (S516).

Thereafter, the central server 200 updates information about the availability of a subband that is allocated to a cell boundary user (S518).

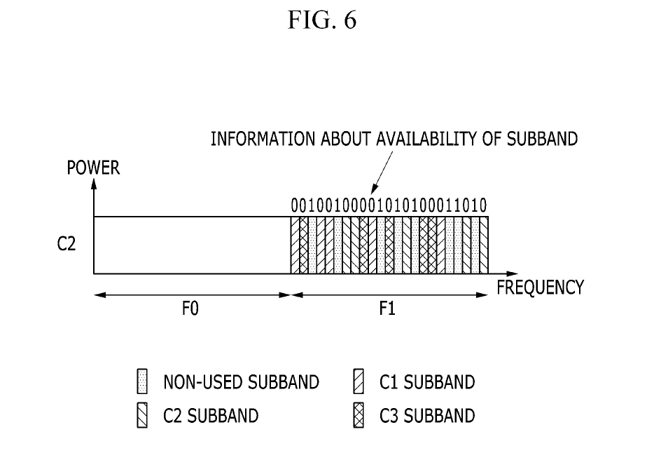

FIG. 6 is a diagram illustrating an example of a method of representing information about the availability of a subband according to an exemplary embodiment of the present invention.

For example, a subband that is allocated to a cell boundary area of the cells C1, C2, and C3 is shown in FIG. 5, and when a subband being used is represented with a bit 0 and when a non-used subband is represented with a bit 1, information about the availability of a subband becomes “00100100001010100011010”, as shown in FIG. 6.

When a new subband is allocated to a cell boundary user, the central server 200 updates information about the availability of a corresponding subband. For example, when a subband being used is represented with a bit 0 and a non-used subband is represented with a bit 1, the central server 200 may update a bit of a corresponding subband from 1 to 0. Further, even when a subband that was being used is no longer used, the central server 200 updates information about the availability of a subband. For example, when a subband being used is represented with a bit 0 and when a non-used subband is represented with a bit 1, the central server 200 may update a bit of a subband that is no longer used from 0 to 1.

The central server 200 stores and manages information data about the availability of a subband at a memory.

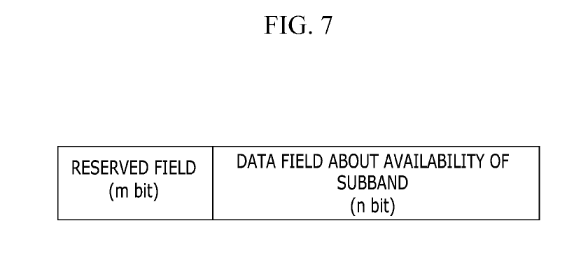

FIG. 7 is a diagram illustrating an example of an information data format about the availability of a subband according to an exemplary embodiment of the present invention.

As shown in FIG. 7, a format of information data about the availability of a subband may be formed with a data field about the availability of a subband of n bits and a reserved data field of m bits. Each bit position of information data about the availability of a subband may correspond to a position of each subband. The reserved data field is a data field that is allocated for a case of adjusting a frequency band F0 for a cell central user and a frequency band Fl for a cell boundary user.

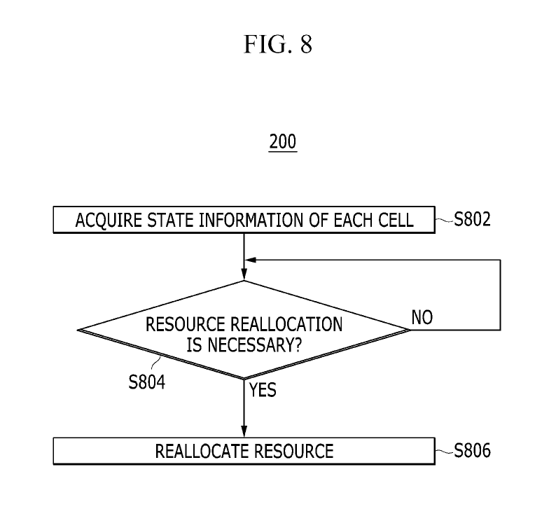

FIG. 8 is a flowchart illustrating a centralized frequency resource reallocation method according to an exemplary embodiment of the present invention.

Referring to FIG. 8, the central server 200 acquires state information of each cell (S802). The state information of a cell includes a load distribution of a cell. The load distribution of the cell may include a load level and a user distribution of a cell central area and a cell boundary area. When knowing a load distribution of each cell, a frequency band F0 for a cell central user and a frequency band F1 for a cell boundary user may be appropriately adjusted to correspond to a traffic load or a user distribution.

The central server 200 determines whether resource reallocation is necessary from state information of each cell (S804). If a load level and a user distribution of a cell central area and a cell boundary area are equal to or larger than a predetermined threshold value, the central server 200 may determine that resource reallocation is necessary.

If resource reallocation is necessary from state information of a cell, the central server 200 performs resource reallocation (S806).

For example, when a traffic load of a cell boundary area is large, the central server 200 may additionally allocate a portion of a frequency band F0 for a cell central user to a frequency band F1 for a cell boundary user. In contrast, when a traffic load of a cell central area is relatively large, the central server 200 may additionally allocate a portion of a frequency band F1 for a cell boundary user to a frequency band F0 for a cell central user.

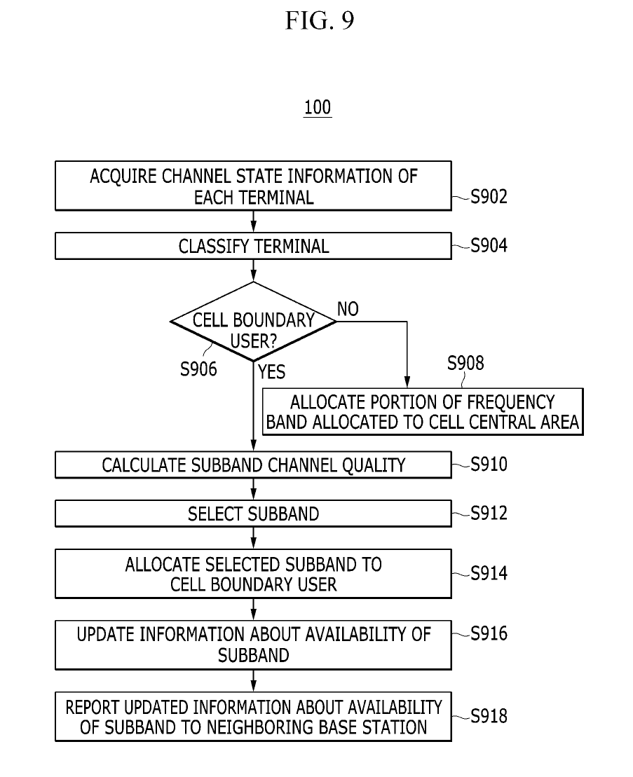

FIG. 9 is a flowchart illustrating a distributed resource allocation method according to another exemplary embodiment of the present invention. Referring to FIG. 9, the base station 100 acquires channel state information of each terminal (S902). In this case, by receiving a report of channel state information from a terminal or by directly measuring channel state information of a terminal, the base station 100 can acquire channel state information of each terminal. By sharing information about the availability of a subband and channel state information of each terminal through cooperation between base stations, the base station 100 can acquire information about the availability of a subband and channel state information of each terminal.

Thereafter, the base station 100 classifies each terminal as a cell central user or a cell boundary user (S904). If a channel state information of a terminal is equal to or larger than a threshold value, the base station 100 classifies the terminal as a cell central user, and if a channel state information of a terminal is less than a threshold value, the base station 100 classifies the terminal as a cell boundary user.

The base station 100 determines whether a terminal is classified as a cell boundary user (S906), and if a terminal is classified as a cell central user, the base station 100 allocates a portion of a frequency band F0 that is allocated for a cell central area service to a corresponding terminal (S908).

If a terminal is classified as a cell boundary user at step S906, the base station 100 calculates quality of a channel that is allocated to a cell boundary area of a corresponding cell on a subband basis (S910). Here, a channel quality calculation method may be the same as that described in the centralized frequency resource allocation method.

The base station 100 selects a subband having the best channel quality based on a calculated channel quality value on a subband basis (S912), and allocates the selected subband to a corresponding cell boundary user (S914). Here, a method of selecting a subband having the best channel quality may be the same as that described in the centralized frequency resource allocation method.

The base station 100 updates information about the availability of a subband that is allocated to a cell boundary user (S916).

Thereafter, the base station 100 reports updated information about the availability of a subband to a neighboring base station (S918). In this way, as the base station 100 reports updated information about the availability of a subband to a neighboring base station, the neighboring base station may know the availability of a subband and each base station may share information about the availability of a subband.

When reporting updated information about the availability of a subband to a neighboring base station, the base station 100 may report all information about the availability of a subband including updated subband the availability information to a neighboring base station. Here, information data about the availability of a subband to report to a neighboring base station may have the data format of FIG. 7.

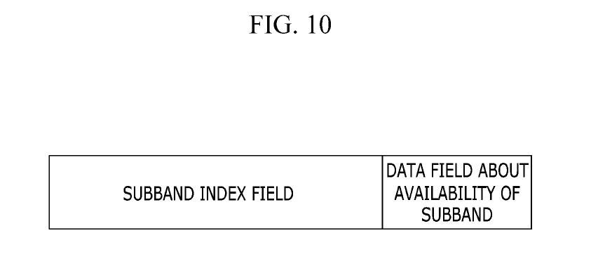

When reporting updated information about the availability of a subband to a neighboring base station, the base station 100 may report an index of an updated subband and information about the availability of the updated subband to adjacent cells. In this case, a format of information data about the availability of a subband to report to a neighboring base station may include a subband index field and a data field about the availability of a subband, as shown in FIG. 10.

The base station 100 may update information data about the availability of a subband even when a subband is no longer used. A neighboring base station that receives a report of information data about the availability of a subband updates information data about the availability of a subband.

The base station 100 may appropriately adjust a frequency band F0 for a cell central user and a frequency band F1 for a cell boundary user according to a load level and a user distribution of a cell central area and a cell boundary area similar to the centralized resource reallocation method. For example, when a traffic load of a cell boundary area is large, a base station may additionally allocate a portion of a frequency band F0 for a cell central user to a frequency band F1 for a cell boundary user. In contrast, when a traffic load of a cell central area is relatively large, a base station may additionally allocate a portion of a frequency band F1 for a cell boundary user to a frequency band F0 for a cell central user.

FIG. 10 is a diagram illustrating another example of an information data format about the availability of a subband according to an exemplary embodiment of the present invention.

Referring to FIG. 10, information data about the availability of a subband to report to a neighboring base station may include a subband index field and a field about the availability of a subband.

The subband index field includes an index of an updated subband. The field about the availability of a subband includes information about the availability of an updated subband.

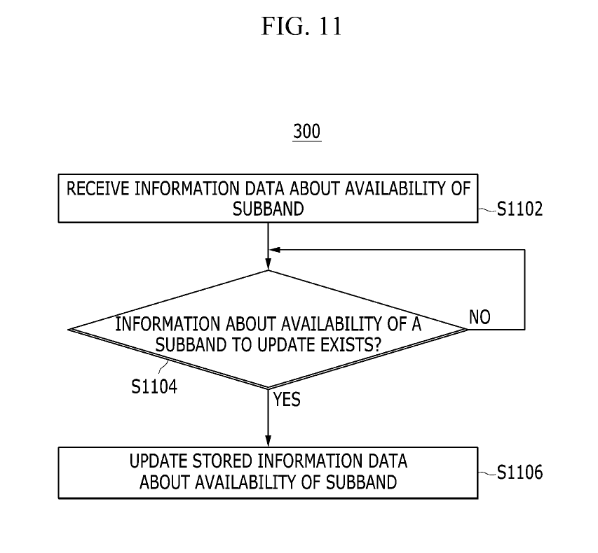

FIG. 11 is a flowchart illustrating an example of a method of updating information data about the availability of a subband of a neighboring base station according to an exemplary embodiment of the present invention.

Referring to FIG. 11, when a neighboring base station 300 receives information data about the availability of a subband from a base station (S1102), the neighboring base station 300 determines whether information about the availability of a subband to update exists (S1104).

If information data to update information about the availability of a subband exists, the neighboring base station 300 updates the stored information data about the availability of a subband (S1106).

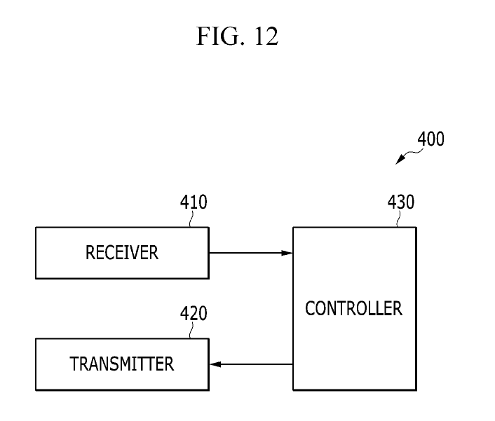

FIG. 12 is a block diagram illustrating a resource allocation apparatus according to an exemplary embodiment of the present invention.

Referring to FIG. 12, a resource allocation apparatus 400 includes a receiver 410, a transmitter 420, and a controller 430. In this case, in a centralized resource allocation method, the central server (200 of FIG. 5) may include the resource allocation apparatus 400. In a distributed resource allocation method, the base station (100 of FIG. 9) includes the resource allocation apparatus 400.

The receiver 410 receives channel state information from a terminal or receives information data about the availability of a subchannel from a neighboring base station.

The transmitter 420 transmits updated information data about the availability of a subband to a neighboring base station.

The controller 430 performs general operations of resource allocation.

Specifically, the controller 430 divides an entire frequency band as a frequency band to allocate to a cell central area and a frequency band to allocate to a cell boundary area, and again divides a frequency band to allocate to the cell boundary area into a plurality of subbands.

The controller 430 classifies a terminal as a cell central user or a cell boundary user, and allocates a portion of a frequency band F0 that is allocated for a cell central area service to a terminal that is classified as the cell central user.

When a terminal is classified as a cell boundary user, the controller 430 calculates quality of a channel that is allocated to a cell boundary area of a corresponding cell on a subband basis, and the controller 430 allocates a selected subband to a terminal that is classified as a cell boundary user based on a calculated channel quality value on a subband basis. Here, a channel quality calculation method and a subband selection method may be the same as that described in the centralized frequency resource allocation method.

The controller 430 allocates a subband to a terminal that is classified as a cell boundary user and updates information about the availability of a subband that is allocated to a cell boundary user. Alternatively, when the controller 430 receives information data about the availability of a subband from a neighboring base station, the controller 430 updates information data about the availability of a subband that the base station stores from the information data about the availability of a subband of a neighboring base station.

The controller 430 may appropriately adjust a frequency band F0 for a cell central user and a frequency band F1 for a cell boundary user according to a load level and a user distribution of a cell central area and a cell boundary area.

At least some functions of a method and apparatus for allocating a resource in a cellular communication system according to an exemplary embodiment of the present invention may be configured by hardware or software lo combined with the hardware. For example, a processor configured by a central processing unit (CPU), a chipset, or a microprocessor, etc. may perform a function of a controller 430. A physical memory may store channel state information received, and information data about the availability of subchannels. Further, a transceiver may perform a receiver 410 or a transmitter 420.

According to an exemplary embodiment of the present invention, in a cellular communication system that is formed with multiple cells, while effectively removing inter-cell interference, resource usage efficiency can be enhanced. Further, by adaptively dividing and allocating a frequency resource according to a user distribution and a load level, resource usage efficiency can be improved and user QoS can be enhanced.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a resource allocation apparatus of a cellular communication system comprising a plurality of cells allocates a resource, the method comprising:
dividing an entire frequency band into a first frequency band to allocate to a cell central area and a second frequency band to allocate to a cell boundary area;
dividing the second frequency band into a plurality of subbands;
allocating the first frequency band or the second frequency band to a terminal within each cell; and
adjusting a size of the first frequency band and the second frequency band according to load distribution information of each cell,
wherein the plurality of cells use commonly the first frequency band and the second frequency band is operated with a resource pool method.

2. The method of claim 1, wherein the allocating of the first frequency band or the second frequency band comprises:
classifying a terminal within each cell as a cell central user that is located at the cell center area or a cell boundary user that is located at the cell boundary area;
allocating a portion of the first frequency band to a terminal that is classified as the cell central user; and
allocating at least one subband of a plurality of subbands of a second frequency band to a terminal that is classified as the cell boundary user.

3. The method of claim 2, wherein the allocating of at least one subband comprises:
calculating quality of a channel that is allocated to a cell boundary area of a corresponding cell on a subband basis; and
allocating the at least one subband based on the channel quality on a subband basis.

4. The method of claim 3, wherein the calculating of a channel quality comprises calculating channel quality of the corresponding subband, by a product of information about an availability of the corresponding subband and channel state information of a corresponding subband,
wherein the information about the availability of the subband is represented with a bit 0 or a bit 1.

5. The method of claim 2, wherein the allocating of at least one subband comprises allocating a subband different from that of a cell boundary user of adjacent cells.

6. The method of claim 2, wherein the allocating of the second frequency band further comprises allocating the at least one subband and updating information about the availability of the plurality of subbands.

7. The method of claim 6, wherein the updating of information comprises reporting information data about the availability of the plurality of subbands to a base station of adjacent cells.

8. The method of claim 7, wherein the reporting of information data comprises reporting an index of an updated subband and information about the availability of an updated subband.

9. The method of claim 6, wherein the information about the availability of the plurality of subbands is represented with a bit 0 or a bit 1, and each bit position of information data about the availability of the plurality of subbands corresponds to a position of each subband.

10. The method of claim 1, wherein the adjusting of a size comprises additionally allocating, if a traffic load or a user load of the cell boundary area is larger than a predetermined threshold value, a portion of the first frequency band to the second frequency band.

11. The method of claim 1, wherein the adjusting of a size comprises additionally allocating, if a traffic load or a user load of the cell central area is larger than a predetermined threshold value, a portion of the second frequency band to the first frequency band.

12. A resource allocation apparatus within each cell in a cellular communication system comprising a plurality of cells, the resource allocation apparatus comprising:
a receiver that acquires channel state information of a terminal within a cell; and
a controller that allocates a portion of a first frequency band to a terminal that is classified as a cell central user, that allocates at least one subband of a plurality of subbands of a second frequency band to a terminal that is classified as a cell boundary user, and that adjusts a size of the first frequency band and the second frequency band according to load distribution information of the cell.

13. The resource allocation apparatus of claim 12, wherein the controller calculates quality of a channel that is allocated to a cell boundary area of a corresponding cell on a subband basis, by a product of information about the availability of a corresponding subband and channel state information of a corresponding subband, and allocates the at least one subband to a cell boundary user based on channel quality on a subband basis,
wherein the information about the availability of a subband is represented with a bit 0 or a bit 1.

14. The resource allocation apparatus of claim 12, wherein the controller additionally allocates a portion of the first frequency band to the second frequency band, if a traffic load or a user load of the cell boundary area is larger than a predetermined threshold value.

15. The resource allocation apparatus of claim 12, wherein the controller updates information about the availability of the plurality of subbands.

16. The resource allocation apparatus of claim 15, further comprising a transmitter that transmits information about the availability of the plurality of subbands to a neighboring base station.

17. The resource allocation apparatus of claim 15, further comprising a transmitter that transmits an index of an updated subband and information about the availability of the updated subband to the neighboring base station.

18. The resource allocation apparatus of claim 12, wherein the at least one subband is different from a subband that is allocated to a cell boundary area of adjacent cells.

19. The resource allocation apparatus of claim 12, wherein the controller classifies the terminal as a cell boundary user or a cell central user based on channel state information of the terminal.
